(19) United States
(12) Patent Application Publication
(10) Pub. No.: US 2011/0173085 A1
(43) Pub. Date: Jul. 14, 2011

(54) Online auction method and system

(76) Inventor: David McNairy, Rockville, MD (US)

(21) Appl. No.: 12/317,105

(22) Filed: Dec. 19, 2008

Related U.S. Application Data
(60) Provisional application No. 61/008,553.

(51) Int. Cl. G06Q 30/00

(52) U.S. Cl. 705/26.3

(57) ABSTRACT

An automated online auction system and method is disclosed wherein the seller and all potential bidders are pre-qualified before they can participate in the auction. In addition, each bid is accompanied by an electronically signed contract from the bidder that makes the bid legally binding if the bid is accepted.

This application claims priority to U.S. Provisional Application No. 61/008,553 filed Dec. 20, 2007.

### FIELD OF THE INVENTION

The present invention relates generally to online auctions and more particularly to a method and system for conducting legally binding online auctions.

### BACKGROUND OF THE INVENTION

In the past 15 years, online auctions and online auction sites have gained incredible popularity. Today, it is possible to participate in auctions for consumer goods, antiques, real estate, sports memorabilia, etc. Just about anything these days is offered for sale on online auction sites.

One problem with present online auction sites is that the bidding is not necessarily binding on either the buyer or the seller. The auction sites do not check to see if the item being offered for sale is actually available. Likewise, the seller does not know if the winning bidder can or will pay the winning price for the item being auctioned. For example, some online auction sites give the winning bidder up to ten days to pay the seller. If the bidder has no intention of paying for the item, the seller will not know for some time after the auction has ended.

Present online auction sites try to combat this problem by using a positive/negative rating system for buyers and sellers. Each party in a transaction can post either positive or negative comments about the other party in a transaction. For example, the buyer may comment on whether the product offered for auction was fairly described and properly delivered to the buyer. The seller may comment on the timeliness and ultimate payment from the buyer. As a result, over time honest buyers and sellers develop a positive trustworthy rating and dishonest buyers and sellers develop negative ratings. These ratings can be used by future buyers and sellers to help determine whether they want to do business with these people in the future.

While the rating system is helpful, the rating system can be manipulated and it does not provide any guarantee that a future online auctions between positively rated buyers and sellers will be successful completed. Thus, there is a need for an online auction system and method which provides legally binding commitments on all parties of an auction.

### SUMMARY OF THE INVENTION

It is therefore a feature and advantage of the present invention to provide an online auction system wherein each participant in the auction is legally bound to perform their part of the auction.

In accordance with one embodiment of the present invention, an automated online auction system and method is disclosed wherein the seller and all potential bidders are pre-qualified before they can participate in the auction. In addition, each bid is accompanied by an electronically signed contract from the bidder that makes the bid legally binding if the bid is accepted.

According to one embodiment of the invention, a method for performing an online auction on an online auction system is disclosed. The method comprises the steps of: pre-approving each seller and the item each seller is auctioning; pre-approving each bidder; attaching a legally binding contract to each bid, wherein a bidder must sign the contract before placing the bid; and concluding the auction when predetermined conditions are met.

According to another embodiment of the invention, an online auction system, comprising a computer system for conducting an online auction, is disclosed. The computer system comprises: a communication module configured to communicate with at least one seller and at least one bidder; a processing module connected to the communication module for conducting the online auction of an item being offered by the seller, wherein the at least one seller is pre-approved before the auction begins and the at least one bidder is pre-approved before the auction system will accept a bid from the bidder; a memory module connected to the processing module for storing information related to the auction; wherein a legally bidding contract for the sale of the item is presented to each bidder and the bid is not accepted by the auction system until the contract is signed by the bidder; wherein the processing module concludes the auction when predetermined conditions are met.

According to another embodiment of the invention, a computer-readable medium having embodied thereon a computer program for processing by a computer is disclosed. The computer program comprises: a first code segment for pre-approving each seller and the item each seller is auctioning; a second code segment for pre-approving each bidder; a third code segment for attaching a legally binding contract to each bid, wherein a bidder must sign the contract before placing the bid; and a fourth code segment for concluding the auction when predetermined conditions are met.

There has thus been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

The invention will now be described, by way of example, with reference to the accompanying drawings, wherein:

FIG. 1 illustrates computer system for use by the online auction system according to one embodiment of the invention;

FIG. 2 is a flow chart illustrating the operation of the online auction system according to one embodiment of the invention;

FIG. 3 illustrates a computer-readable medium according to one embodiment of the invention.

### DETAILED DESCRIPTION OF PREFERRED EMBODIMENTS OF THE INVENTION

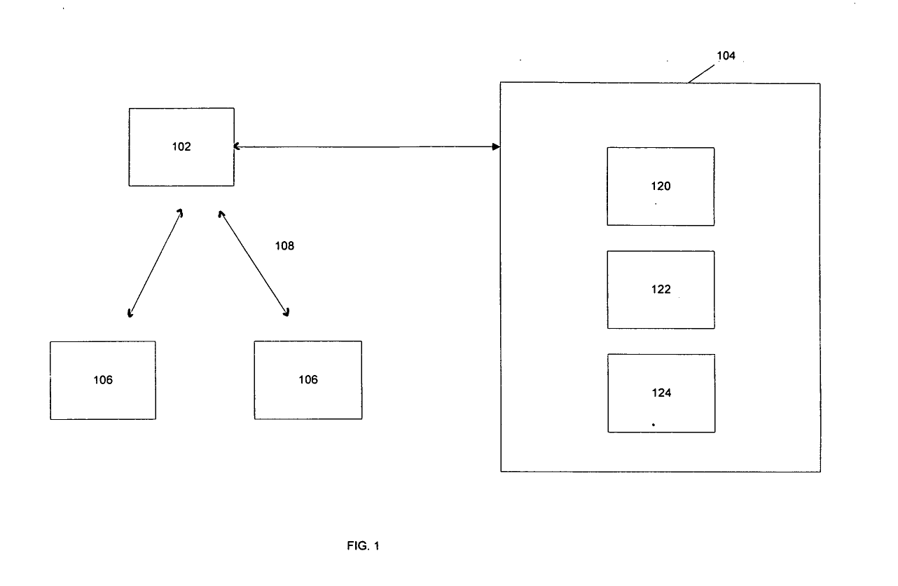

FIG. 1 illustrates an online auction system 100 according to one embodiment of the invention. The online auction system 100 comprises a website 102 and computing equipment 104 connected to the website for running the operation of the website. For example, the computing equipment 104 can comprise a communications module 120 for providing communication with at least one seller and at least one bidder through the website 102, a processing module 122 for conducting the online auction of an item being offered by the seller and a memory module 124 for storing information related to the auction. The computing equipment 104 also comprises software for managing the operation of the website in the manner described below. A plurality of external computers 106 may access the website 102 using the Internet via links 108.

The invention will now be described with reference to an illustrative example which pertains to an online auction of real estate. It will be understood by one skilled in the art that the present invention may involve the online auction of any good, product, property (real estate), service, financial loans or commercial paper and the invention is not limited thereto.

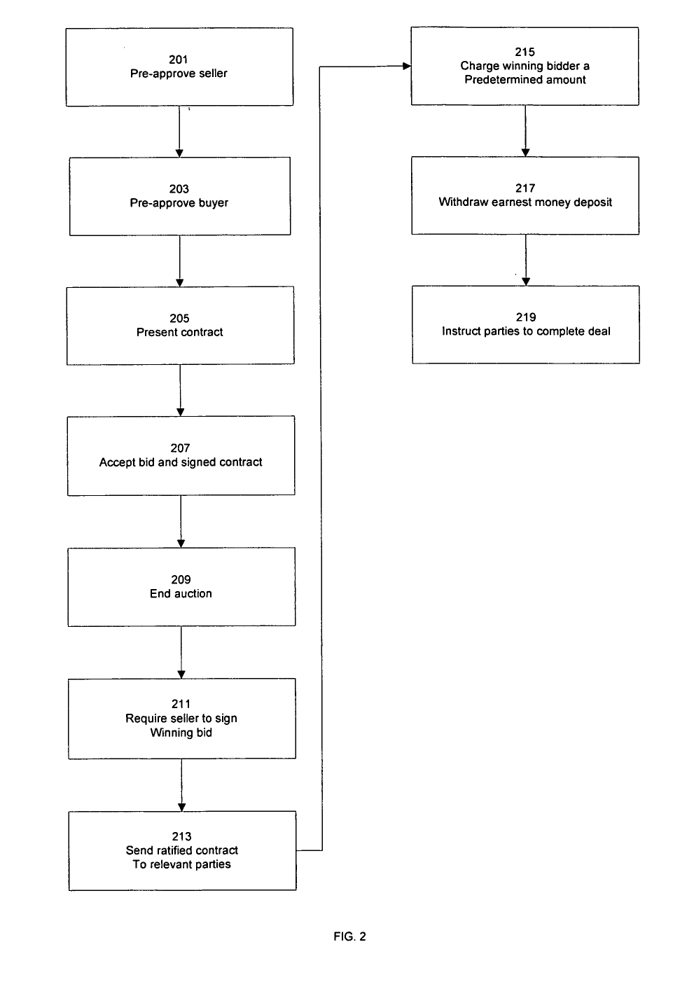

The operation of the online auction system according to one embodiment of the invention will now be described with reference to FIG. 2. When the seller wants to sell a piece of real estate or other item, the seller and the property must first be pre-approved by the online auction system 100 in step 201. To be pre-approved, the seller must first prove that the seller has the right to sell the property or item. This may be accomplished in a variety of ways including uploading a copy of the title to the property to the online auction system 100. Once approved, the details of the property are gathered from the seller and then displayed on the online auction website 102.

Bidders can bid using the inventive online auction website only after they have been pre-qualified to bid on the online auction system in step 203. To pre-qualify, the bidder must have a lender either associated with the online auction system or another authorized lender and a pre-qualified line of credit, or post cash in the amount that the bidder wants to qualify for. Once the bidder has been pre-qualified, the bidder can bid on any property being auctioned on the online auction website but is limited to a maximum bid of their pre-qualified limit.

When a bidder wants to place a bid on a property, the automated online auction system 100 automatically presents a contract based on the seller's previously set parameters to the bidder in step 205. The bidder must electronically sign the contract for the sale of the property at the price of the bid before the bid is placed in step 207. The contract is legally binding in all 50 states. Thus, a binding legal contract is attached to each bid made on the property.

The online auction is run in a manner similar to other known online auctions. The bidder may either place a single bid at a particular price or the bidder can place a minimum bid with a maximum bid. The online auction system can automatically raise the minimum bid incrementally as bids come in from other bidders up to the maximum bid.

One feature of the inventive online auction system 100 is that the bidder can make prioritized bids on a plurality of properties at the same time. For example, the bidder may want to bid on three different properties in a subdivision but only want to purchase one of the properties. The bidder assigns a priority level to each of the properties from highest to lowest. The bidder's bid on the highest priority property is placed on the selected property so long as it is higher than the current highest bid for the property. If the bidder's bid is the highest at the end of the auction, the bidder has bought the selected property. However, if the bidder is out bid on the first property, the online auction system 100 immediately places the bidder's bid on the second highest property. This continues until either the bidder wins the auction for one of the properties on his list or the bidder is out bid on all of the properties.

When the auction ends, the bidder with the highest bid is deemed the winner of the auction so long as predetermined conditions are met, e.g., the seller's reserve price has at least been met or the time period for the auction has expired in step 209. The online auction system 100 requires the seller to electronically sign the winning bidder's signed offer/bid to create a ratified contract in step 211. Now that the conditions for sale have been met, the electronically ratified contract is sent electronically to all relevant parties in step 213. The online auction system 100 immediately charges the winning bidder a first predetermined amount of money to cover any auction system related fees and other known expenses either on a credit card or bank account provided previously by the bidder in step 215. The online auction system 100 then automatically withdraws the required earnest money deposit and any additional fees from the banking account that the bidder had previously identified and authorized the online auction system to deduct in step 217. The online auction system 100 then instructs the winning bidder and the seller then complete the sale of the property within a second predetermined period of time in step 219.

The online auction system 100 also provides text messages regarding an ongoing auction to the seller and/or the bidders. These messages can provide a variety of information relating to the ongoing auction, such as, current bids, identity of bidders, etc. Furthermore, if a potential bidder provides a list of desired criteria for the type of property the bidder would like to buy, the online auction system 100 will search for properties that meet the criteria and notify the bidder of any matching property that is available. In addition, the online auction system 100 can match local vendors to criteria selected by the bidder and send the information to the bidder. For example, if the bidder is going to remodel a kitchen if they win the auction, the bidder can indicate this to the online auction system either during or after the auction and the online auction system can send the bidder information on local companies who can perform some or all of the remodeling or provide other necessary goods or services.

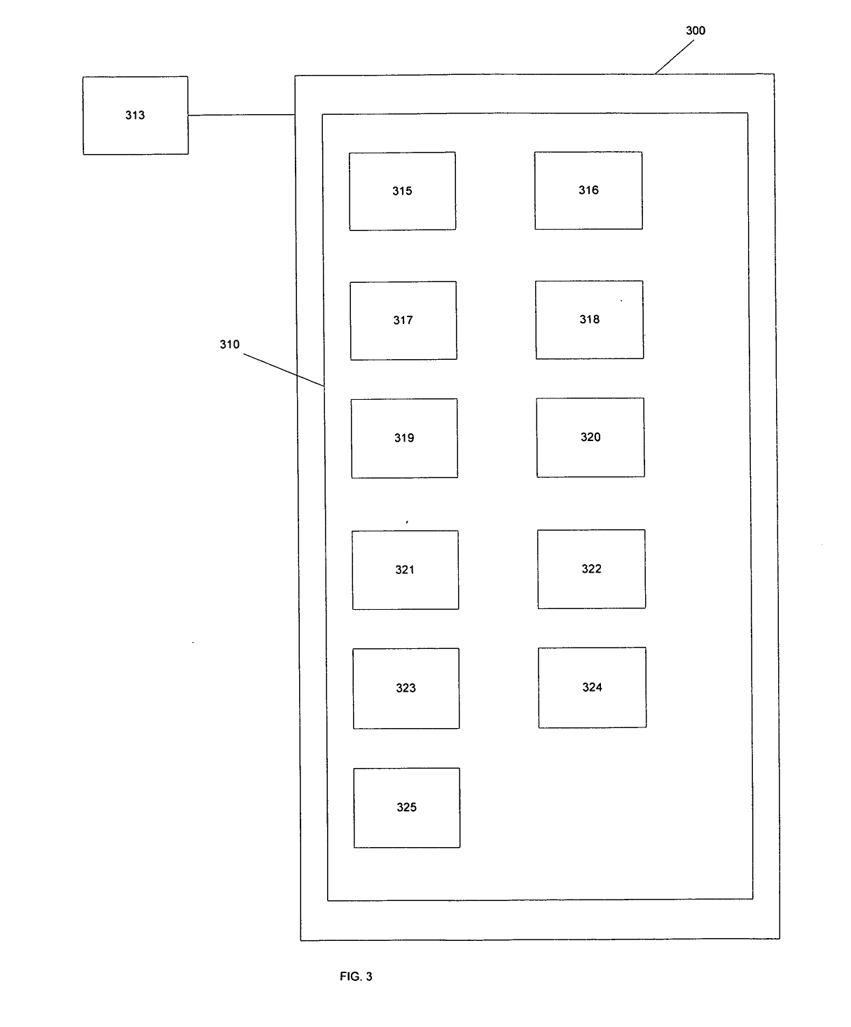

In another embodiment of the invention according to FIG. 3, a computer-readable medium is illustrated schematically. A computer-readable medium 300 has embodied thereon a computer program 310 for processing by a computer 313, the computer program for processing by a computer, the computer program comprising code segments for conducting an online auction. The computer program comprises a first code segment 315 for pre-approving each seller and the item each seller is auctioning; a second code segment 316 for pre-approving each bidder; a third code segment 317 for attaching a legally binding contract to each bid, wherein a bidder must sign the contract before placing the bid; and a fourth code segment 318 for concluding the auction when predetermined conditions are met. In addition, the computer program also comprises a fifth code segment 319 for accepting the highest bid that meets the seller's conditions; a sixth code segment 320 for requesting the seller to electronically sign the winning bid to create a ratified contract; a seventh code segment 321 for sending the ratified contract to relevant parties; an eighth code segment 322 for charging the account of the winning bidder a previously agreed upon amount of money; a ninth code segment 323 for charging an identified account of the winning bidder for an earnest money deposit; and an tenth code segment 324 for providing a first time period for the seller and the winning bidder to complete the sale of the item.

The many features and advantages of the invention are apparent from the detailed specification, and thus, it is intended by the appended claims to cover all such features and advantages of the invention which fall within the true spirits and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

1. A method for performing an online auction on an online auction system, comprising the steps of:
pre-approving each seller and the item each seller is auctioning;
pre-approving each bidder;
attaching a legally binding contract to each bid, wherein a bidder must sign the contract before placing the bid; and
concluding the auction when predetermined conditions are met.

2. The method according to claim 1, wherein the item to be auctioned is at least one of the group comprising real estate, goods, products, services, financial loans and/or commercial paper.

3. The method according to claim 2, wherein the seller is pre-approved by providing information to the system which proves that the seller has the right to sell the item.

4. The method according to claim 3, wherein the auction system receives an uploaded copy of the title to the real estate.

5. The method according to claim 2, wherein the bidder is pre-approved by having a pre-qualified lender with an approved line of credit.

6. The method according to claim 5, wherein a maximum bid by the bidder is limited to the approved line of credit.

7. The method according to claim 2, wherein the bidder is pre-approved by depositing cash into an account with the auction system.

8. The method according to claim 1, further comprising the steps of:
accepting the highest bid that meets the seller's conditions;
requiring the seller to sign the winning bid to create a ratified contract;
sending the ratified contract to relevant parties;
charging the account of the winning bidder a previously agreed upon amount of money;
charging an identified account of the winning bidder for an earnest money deposit; and
instructing the seller and the winning bidder to complete the sale of the item within a first time period.

9. The method according to claim 1, wherein the bidder electronically signs the contract before making the bid.

10. The method according to claim 1, wherein the auction system can incrementally raise a minimum bid received from a bidder as higher bids are received from other bidders up to a pre-specified maximum bid.

11. The method according to claim 3, wherein the auction system receives an uploaded inspection report on the real estate.

12. An online auction system, comprising a computer system for conducting an online auction, comprising:
a communication module configured to communicate with at least one seller and at least one bidder;
a processing module connected to the communication module for conducting the online auction of an item being offered by the seller, wherein the at least one seller is pre-approved before the auction begins and the at least one bidder is pre-approved before the auction system will accept a bid from the bidder;
a memory module connected to the processing module for storing information related to the auction;
wherein a legally bidding contract for the sale of the item is presented to each bidder and the bid is not accepted by the auction system until the contract is signed by the bidder;
wherein the processing module concludes the auction when predetermined conditions are met.

13. The online auction system according to claim 12, wherein the item to be auctioned is at least one of the group comprising real estate, goods, products, services, financial loans and/or commercial paper.

14. The online auction system according to claim 13, wherein the seller is pre-approved by providing information to the system which proves that the seller has the right to sell the item.

15. The online auction system according to claim 14, wherein the auction system receives an uploaded copy of the title to the real estate.

16. The online auction system according to claim 13, wherein the bidder is pre-approved by having a pre-qualified lender with an approved line of credit.

17. The online auction system according to claim 16, wherein a maximum bid by the bidder is limited to the approved line of credit.

18. The online auction system according to claim 13, wherein the bidder is pre-approved by depositing cash into an account with the auction system.

19. The online auction system according to claim 12, wherein the bidder electronically signs the contract before making the bid.

20. The online auction system according to claim 12, wherein the auction system can incrementally raise a minimum bid received from a bidder as higher bids are received from other bidders up to a pre-specified maximum bid.

21. The online system according to claim 12, wherein the seller electronically signs the winning bid and the ratified contract is sent to relevant parties.

22. The online system according to claim 12, wherein the processing module requires the seller to sign the winning bid to create a ratified contract, sends the ratified contract to relevant parties, charges the account of the winning bidder a previously agreed upon amount of money, charges an identified account of the winning bidder for an earnest money deposit, and instructs the seller and the winning bidder to complete the sale of the item within a first time period.

23. A computer-readable medium having embodied thereon a computer program for processing by a computer, the computer program comprising:
a first code segment for pre-approving each seller and the item each seller is auctioning;
a second code segment for pre-approving each bidder;
a third code segment for attaching a legally binding contract to each bid, wherein a bidder must sign the contract before placing the bid; and
a fourth code segment for concluding the auction when predetermined conditions are met.

24. The computer-readable medium according to claim 23, further comprising:
a fifth code segment for accepting the highest bid that meets the seller's conditions;
a sixth code segment for requesting the seller to electronically sign the winning bid to create a ratified contract;
a seventh code segment for sending the ratified contract to relevant parties;
an eighth code segment for charging the account of the winning bidder a previously agreed upon amount of money;
a ninth code segment for charging an identified account of the winning bidder for an earnest money deposit; and
an tenth code segment for providing a first time period for the seller and the winning bidder to complete the sale of the item.
